(19) United States
(12) Patent Application Publication
(10) Pub. No.: US 2008/0091740 A1
(43) Pub. Date: Apr. 17, 2008

(54) Method for managing a partitioned database in a communication network

(75) Inventors: Erwan Le Merrer, Tregastel (FR); Didier Neveux, Cavan (FR); Pierre Crepieux, Lannion (FR)

Correspondence Address: COHEN PONTANI LIEBERMAN & PAVANE LLP, Suite 1210, 551 Fifth Avenue, New York, NY, 10176, US

(73) Assignee: France Telecom, Paris (FR)

(21) Appl. No.: 11/974,012

(22) Filed: Oct. 11, 2007

(30) Foreign Application Priority Data
Oct. 12, 2006 (FR) 06/54211

(51) Int. Cl. G06F 17/30

(52) U.S. Cl. 707/201

(57) ABSTRACT

A method for managing a database in a communication network comprising the following steps: at least some of a segment to be copied from the database is copied to a copied segment; at least one node which is part of the communication network and intended to receive the copied segment is selected; wherein the node is selected on the basis of a capacity information item which is characteristic of it.

### FIELD OF THE INVENTION

The present invention relates to the field of communication networks and particularly to the management of databases which are present in these networks. More particularly, the invention allows an improvement in the management of databases partitioned into segments in a pair network.

### BACKGROUND OF THE INVENTION

Management of a database must guarantee that a user has permanent access to the data. This permanence is assured, in particular, by a copy of all or part of the database on a plurality of nodes in this network. Thus, even if a node is removed from the network, no data are lost.

One of the current techniques for storing data in a pair network is to use hash tables distributed over a plurality of nodes. Each node receiving a table is responsible for this table. To assure permanent access to the data, hash tables are copied on other nodes.

By virtue of the distribution of the hash tables, the nodes receiving the copy of a table are the nodes which are closest to the node responsible for this table. In fact, these nodes are not necessarily the most suitable to receive this copy. This does not allow effective management of the database.

### SUMMARY OF THE INVENTION

In accordance with one embodiment, the present invention allows all or some of the aforementioned drawbacks to be overcome or at least reduced.

A first subject matter of the present invention relates to a method for managing a database in a communication network comprising a step of copying at least some of a segment to be copied from the database to a copied segment; a step of selecting at least one node which is part of the communication network and intended to receive the copied segment; the node being selected on the basis of a capacity information item which is characteristic of it.

Thus, the node which has a very high capacity is selected as priority for association with the copied segment. Management of the database is then optimized thereby.

On the basis of the non-limiting preferential embodiments, the first subject matter of the invention has the additional features taken separately or in combination which are set out below:

The copied segment and the segment to be copied are identical. Thus, a plurality of nodes store the same segment from the database. If a node disappears, the data will not be lost.

The node is selected on the basis of a data storage capacity for said node.

Thus, it is assured that the node receiving the copied segment is capable of storing it.

The node is selected on the basis of a memory capacity for said node.

Thus, it is assured that the node receiving the copied segment is capable of responding to requests coming from other nodes or from a promoter outside the network.

The selected node is part of a pair network.

Investment in hardware and the associated operating costs will thus be limited. Indeed, the node is located at the premises of a client.

A second subject matter of the invention relates to a piece of equipment in a communication network comprising means for copying at least some of a segment to be copied from the database to a copied segment; means for selecting at least one node which is part of the communication network and intended to receive the copied segment; the selection means being capable of selecting the node on the basis of the capacity information item which is characteristic of it.

A third subject matter of the invention relates to a communication system including a database which is made up of a plurality of segments stored on a plurality of nodes which are part of a communication network, said nodes comprising pieces of equipment in accordance with the piece of equipment above.

On the basis of non-limiting preferential embodiments, the communication system which is the subject matter of the invention has the additional features taken separately or in combination which are set out below:

Nodes storing identical segments from the database are connected to one another to form subnetworks.

The communication between the different nodes, which are part of the same subnetwork, is improved thereby. The volumetric analysis of the data to be stored is moreover suited to the storage capacity of the nodes while making it easier to manage the data in the base.

Connections link the subnetworks to one another. This makes it possible to move from one subnetwork to another in order to look for a data item instead of exploring all of the nodes of the pair network. Looking for data in the base, which are partitioned over different nodes, is made easier thereby.

A fourth subject matter of the invention relates to a computer program comprising portions of code for executing the steps of a method as described above when the program is executed on said computer.

A fifth subject matter of the invention relates to an offer to download a computer program as described above from a copy of said program stored on a recording medium.

### BRIEF DESCRIPTION OF THE DRAWINGS

The invention will be better understood and other special features and advantages will emerge upon reading the description, which is given by way of example, this description referring to the appended drawings, in which:

FIG. 1 shows a node in a communication network based on the invention;

FIG. 2 shows a communication system based on the invention; and

FIG. 3 shows a method for managing a database based on the invention.

### DETAILED DESCRIPTION OF THE DRAWINGS

Aspects of the invention are described below in a particular application to a pair network. However, the concepts of the invention can likewise be applied to any communication network which contains a partitioned database.

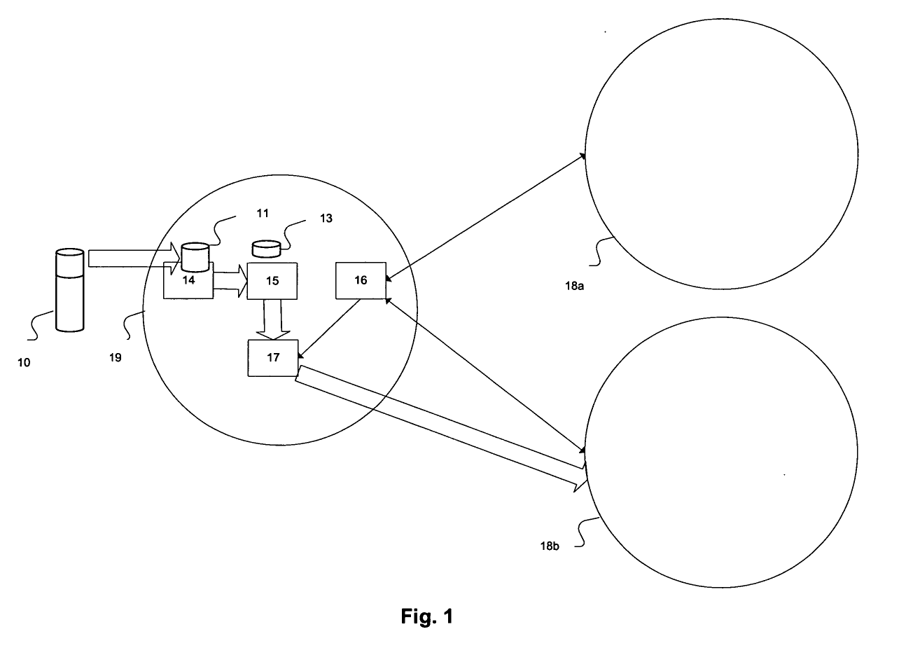

FIG. 1 shows a node 19 which is part of a communication network. For example, this node is a computer. As a variant, the node is a fixed or mobile telephone, or any other communication terminal.

The node 19 has a piece of equipment having means for storing 14 a segment to be copied 11 from a partitioned database 10. It likewise has means for copying 15 at least some of the segment to be copied 11 to a copied segment 13. In one embodiment, the segment to be copied 11 and the copied segment 13 are different. As a variant, the segment to be copied 11 and the copied segment 13 are identical, which is particularly the case when a replica of the segment to be copied 11 from the database 10 needs to be implemented on other nodes 18a, 18b. In this case, the node 19 is connected, in non-limiting fashion, to a plurality of other nodes 18a, 18b which are part of the communication network. Selection means 16 send interrogation messages to the other nodes 18a, 18b. In response, the latter send a piece of information about their capacity. By way of example, this information is the storage capacity of the node. As a variant, this information is the memory capacity of the node or the power of the processor. In another variant, this information is the capacity of the passband used by the node. In another variant, the information comprises all of these capacities. In another variant, the information returned may be an OK or not OK. From the information coming from the different nodes 18a, 18b, the selection means 16 will select the node or nodes most suited to receiving the copied segment 13 from the database. The transmission means 17 then send the copied segment 13 to at least one node 18a, 18b selected for its capacity. Thus, the node which has a very high capacity is selected as priority for association with the copied segment. Management of the database is then optimized thereby.

As a variant, it will be noted that a node is capable of storing different base segments.

Once at least one node 18a, 18b has received the copied segment 13, this segment is, by way of example, deleted from the storage means 14 of the node 19. The segment to be copied 11 is then replaced by a new segment to be copied 11 without the segment 13 which has been copied. As a variant, the segment to be copied 11 remains entirely stored in the means 14.

The database 10 collects and processes information, for example, for statistical analysis purposes. As a variant, the database is used to store contents such as the profile of a client, conversational messages, films or the like.

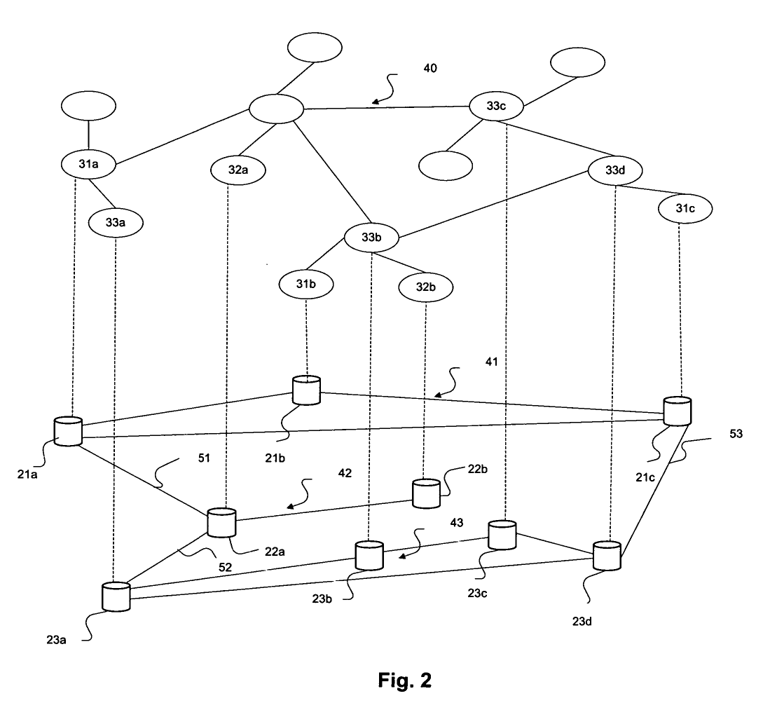

FIG. 2 shows a communication system including a database 10 which is made up of a plurality of nodes. In this case, the database is partitioned into segments 21a, 22a, 23a, which are arranged on nodes 31a, 32a, 33a forming a pair network 40.

A pair network is a network in which each node simultaneously plays the role of server and client not requiring the use of a dedicated centralized server to perform the tasks which the node has to discharge.

These nodes are connected, that is to say that they exchange information with one another, for example about the state of the network. Indeed, a pair network is by nature dynamic. The nodes are frequently connected and disconnected to/from this network, independently of one other. It is then necessary for the nodes which form the network to inform one another of these changes.

The topologies of a pair network are variable. FIG. 2 shows a topology in which the nodes are on the same hierarchic level. As a variant, the topology of the network is of hybrid type. In this topology, super-pairs, chosen from the nodes, play the role of servers towards the other nodes.

In this case, the database 10 is partitioned, in non-limiting fashion, into three segments 21a, 22a, 23a.

A segment of the database is understood to mean a piece of the base such that the association of all of the segments allows the database 10 to be reconstructed in its entirety. The segments are of the same size. As a variant, the segments are of different size.

Each segment is associated with a node 31a, 32a, 33a in the network. By way of example, the segment 21a is associated with the node 31a, and the segments, 22a, 23a are associated with the nodes 32a and 32b, respectively. Associated is understood to mean that the segments of the database 10 are stored in storage means 14 which are part of the nodes. By way of example, these storage means 14 may be the hard disk of a computer. Thus, a node is used to store only a piece 10 of the database. This allows the work carried out by each of the nodes to be minimized. This work involves storage operations and/or request-processing operations. These requests come from other nodes. As a variant, these requests come from a promoter outside the network.

In order to initialize the set-up of the database in the pair network, a partition means outside the pair network partitions the database 10 into a plurality of segments 21a, 22a, 23a. These segments are then associated with the nodes 31a, 32a, 33a.

In one variant embodiment, the database is set up in the network using a single node which receives all the segments making up the database 10. By way of example, the node is chosen for its capacities and/or the features of its connection to the network.

A segment stored on a node needs to be copied for different reasons.

By way of example, a segment to be copied 21a needs to be copied in order to form the segments 22a, 23a. The segments 21a, 22a, 23a then form separate segments of the database 10. There is then the assurance that the database can be upgraded, which is linked to the growth and shrinkage of said base.

In another use, a segment to be copied 21a, 22a, 23a needs to be copied in order to form the copy segments 21b, 21c identical to the segment 21a, the copy segments 22b, 22c identical to the segment 22a, and the copied segments 23b, 23c identical to segment 23a. These identical copies allow the permanence of the data to be assured. The permanence of the data is a problem linked to the dynamic of the pair network. Indeed, data can be lost when a node storing a segment of the database 10 is disconnected. This permanence is then assured by the copy of the segment to be copied on one or more other nodes.

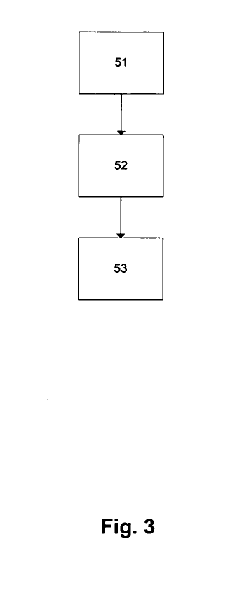

FIG. 3 shows a method for managing a database in a communication network which allows copying of a segment to be copied.

By way of example, the copied segments are different from the segment to be copied. The method thus has a step of copying 51 the segment to be copied 21a to one or more copied segments 22a, 23a. A selection step 52 allows at least one node 32a, 33a to be chosen which is capable of receiving the copied segment or segments 22a, 23a. A transmission step 53 allows the copied segment or segments 22a, 23a to be sent to the selected node or nodes 32a, 33a.

In another example, the copied segments are identical and form one or more copies of the segment to be copied. The method thus has a step of copying 51 the segment to be copied 21a, 22a, 23a to one or more copied segments 21b, 21c, 22b, 23b, 23c, 23d. A selection step 52 allows at least one node 31b, 31c, 32b, 33b, 33c, 33d which is capable of receiving the copied segment or segments 21b, 21c, 22b, 23c, 23d to be chosen. A transmission step 53 allows the copied segment or segments 21b, 21c, 22b, 23b, 23c, 23d to be sent to the selected node or nodes 31b, 31c, 32b, 33b, 33c, 33d.

The pairs storing the identical segments 21a, 21b, 21c, as well as 22a, 22b, and 23a, 23b, 23c, 23d are connected to one another to form autonomous subnetworks or layers 41, 42, 43 within the pair network 40. These layers thus form a new level of interconnection between the nodes of the communication network. By way of example, the nodes which are part of the subnetworks are connected in decentralized pair-to-pair fashion.

The number of subnetworks required is modulated on the basis of the storage capacity of the nodes and the mass of information to be stored. Thus, a database which is too large to be accommodated totally by a subnetwork will be chopped into a plurality of segments. Each segment is stored by an autonomous layer.

The method for managing the database in the communication network is implemented by a computer program, for example. This program can be loaded into the internal memory of a computer. It particularly comprises portions of code for executing the steps of said management method when it is executed on the computer.

The invention also relates to an offer to download a computer program from a copy of said program stored on a recording medium.

Thus, the pair network is used for classical services, such as accessing the network or routing. The autonomous subnetworks or layers are themselves used to guarantee the permanence of the data in the network and to facilitate the communications between the nodes in one subnetwork.

As a variant, it will be noted that the subnetworks can contain nodes which have different base segments. A node can therefore be part of a plurality of subnetworks.

Within a subnetwork, the number of copies must not fall below a certain minimum threshold, at the risk of losing the data stored. Equally, the number of copies must not exceed a certain maximum threshold, at the risk of making the copies more difficult to keep consistent and manage. These thresholds are defined on the basis of the dynamics of the network. Once the thresholds have been determined, the number of copies required needs to be maintained.

A first mechanism for maintaining this number is based on a method which is referred to as local. In this method, each neighbour to a copy which has disappeared looks, with a probability of 1/N, for a node in the network 40 to replace this node which has disappeared. N corresponds to the average number of neighbours for each copy in a given layout. This number is predefined by the manager of the network 40, for example.

This first mechanism can have a second method, referred to as global, associated with it. This second method requires the nodes to know the total number T of copies in a layer with which they are associated. To know this number T, it is possible to use methods such as random steps, aggregation or probabilistic polling. The average checking rate is dependent on the dynamics of the network, that is to say on the rate at which the nodes disappear. When a node detects that the number of copies in a given layer is below a predefined minimum threshold, it will, then, manage the creation of one or more copies in line with the method from FIG. 3.

In one variant, referred to as semi-global, an election system allows the node or nodes which will take responsibility for creating the copies to be chosen. By way of example, this election is implemented by means of a piece of information broadcast in the layer in which it is necessary to replace the lost copies.

When a pair is selected to receive a copied segment, it is necessary for it to integrate itself into the subnetwork 41, 42, 43 of node storing said segment. By way of example, the address of this new node is broadcast to the other nodes of this subnetwork. These other nodes will then suggest to it that it be interconnected using one of the classical methods of the pair networks. As a variant, when a node is selected to receive a determined base segment, a list of pairs storing the same subsection is communicated to it. This list is provided by the node which made the selection. As a variant, the list is provided by a super-pair or any other node in the network. In this case, it is up to the selected node to set up connections to the nodes which already exist within the subnetwork 41, 42, 43 chosen.

The new node which has been recruited obtains a copy of the segment to be copied using the method from FIG. 3. It obtains it from the node which recruited it. As a variant, it obtains it from any node which has the segment to be copied. For example, this the node which is most readily available or the closest. In another variant, it obtains it by means of “hoarding”, that is to say from a plurality of nodes. This minimizes the local load on each node.

It will be noted that the phase of integrating the node in the subnetwork and the phase of copying the segment are, as a variant, chronologically reversed.

It will also be noted that it is possible to have a delay between the phase of detecting disconnection of a node and selection of one or more nodes to replace this node. It will thus be possible to take account of when a node in the network is disconnected for a short time.

The contents of the different copies must be identical. A guarantee of this consistency is indispensable to any modification of a copy, that is to say to the creation, deletion or modification of the data in the base. By way of example, the data are modified by a request from a promoter. Indeed, the data change over time, and it is therefore necessary for the data in the different copies to change simultaneously. A first embodiment involves each request to modify the data being sent by multicast to all the copies. A single positive acknowledgement among the multiple responses from the various nodes storing the copy will suffice to validate the change. In another embodiment, each request is sent to a determined node. Once the change has been made in the segment which it stores, this change is broadcast to the other nodes forming the subnetwork for the determined base segment. This broadcast is in multicast mode. As a variant, the broadcast is by degrees. The change is not validated with the promoter until it is effective in all the copies of the subnetwork. As a variant, the change is validated when it is effective in some of the copies of the subnetwork.

Moreover, outside the change phases, a regular consistency check is preferably set up. Thus, the nodes storing identical base segments compare their contents. To optimize this comparison, the nodes interchange the hashes of the copies. A hash is an imprint, obtained by applying a hash function to a set of data. The properties of the hash functions guarantee that if two hashes are identical then the initial contents can only be identical. Conversely, if the hashes are different then the data from which they are calculated are different. Thus, if the hash received from a first node by a second node is identical to the hash of the copy of the second node then the contents of the two nodes are consistent. Conversely, a different hash signifies a difference between the two copies. In this case, the two nodes communicate in order to find the data giving rise to the inconsistency. These nodes then synchronize themselves to the data changed most recently. To this end, the modified data are dated. The nodes thus interchange the data changed most recently. This is because these are the data which are highly likely to contain the inconsistency.

As a variant, the nodes interchange smaller and smaller data hashes in order to refine the localization of the inconsistent data item.

In some situations, the same data item from the base is changed simultaneously by two different promoters. In this case, it is necessary to insert an additional parameter, like the IP address of the change promoter of the change. The change from the promoter which has the highest address has priority over the other change, for example.

When a node is connected or reconnected, consistency is likewise ensured by the new entrant in order to take account of the changes during the period in which it was not connected.

The nodes which are part of a particular sublayer are thus synchronized to each other.

It will be noted that the upgradeability of the database is linked to the number of clients or to the telecommunication service using this base, for example.

The communication system including the database is thus based on nodes storing segments of the database which are connected to one another to form subnetworks. These connections allow adaptation of the volumetric analysis of the data to be stored to the storage capacity of the nodes.

In one embodiment, the storage capacity of each node in the subnetwork is fixed as identical. This capacity is fixed by a manager of the network, for example. In this case, recruitment of a node will be subject to the obligation for said node to be able to assure this storage capacity. As a variant, the storage capacity of each node is determined dynamically as the minimum capacity of the node in the subnetwork with the lowest level of performance. Thus, each node broadcasts the maximum storage capacity which it provides for the subnetwork. Each node then retains the lowest capacity among the nodes of the subnetwork. It will be noted that the broadcast is in multicast mode or by degrees. As a variant, each node is free of the storage capacity which it provides for the subnetwork.

When a subnetwork reaches storage saturation, it is then necessary to create a new subnetwork. Storage saturation is dependent on the maximum number of nodes in a subnetwork and on the threshold of storage fill. This threshold is 90%, for example. This threshold allows the addition of data in the subnetwork to be accepted during the phase of creating new subnetwork. If 100% saturation is reached, any new addition of data is blocked.

Upon storage saturation, each node of the saturated subnetwork elects a new node to be positioned in a new subnetwork. The nodes of the saturated subnetwork then exchange the addresses of the new nodes. These addresses are then supplied to each new node. These new nodes then set up connections among themselves in order to structure the new subnetwork. Links between the subnetworks are likewise created in order to handle the communications between the subnetworks. In this embodiment, it is necessary for all the nodes of the saturated subnetwork to have the saturation information.

In one variant embodiment, a node in the saturated subnetwork elects a new node to be installed in the new subnetwork which is to be created. This new node will receive a copy of at least some of a segment of the base stored in the saturated node using the method from FIG. 3. This new node is then responsible for electing other nodes to form the new subnetwork. In this case, the method from FIG. 3 will likewise be used to create copies. The node from the saturated level and the new node exchange addresses intended to create the links 51, 52, 53 between the subnetworks. The nodes of the saturated subnetwork are likewise aware of the creation of a subnetwork. If all the nodes have the same storage capacity then it is the node which originally received the request of input of new data which will take responsibility for initiating the process of creating a new subnetwork. If the nodes from the level have different storage capacities then it is the saturated node which has to initiate the process.

This saturation management allows the volume of data which is stored on each node of the network to be limited.

In an unorganized base, when a request for the input of new data is sent to a saturated subnetwork, said request is routed to the subnetwork which has the resource required for storage. If no subnetwork has any space available, the last subnetwork created initiates creation of a new subnetwork. A mechanism of this kind prevents the anarchic creation of subnetworks and optimizes use thereof.

In an organized base, it is not the last subnetwork which initiates creation of a new subnetwork but rather the saturated subnetwork directly. This allows order to be maintained between the subnetworks so that the data are always organized in the base.

There are likewise requests for data to be deleted from the base. In the case of an unorganized base, this request is disseminated through all the subnetworks so as to reach the subnetwork which holds these data. In order to reduce the time for executing the request, it is disseminated in parallel within the subnetworks along a plurality of paths.

In order to optimize management of the subnetworks, a minimum filling threshold and a filling threshold fixed before deletion of the subnetwork are provided. The minimum filling threshold allows the subnetwork storing little data to be destroyed. These data are then reallocated to another subnetwork. The aim of the filling threshold fixed before election is possible is to get around the incessant cycles of creating and deleting a new subnetwork which has not reached the minimum filling threshold. This allows definition of a hysteresis cycle in the management of the changes in the subnetwork.

Once the decision has been taken to destroy a subnetwork, said subnetwork requests the subnetworks to which it is connected. It then transmits the data to one of them. Different cases arise. On the one hand, a subnetwork is capable of receiving the data from the subnetwork which is to be destroyed, in which case the transfer is made. This transfer concerns not only the data but also the connections 51, 52, 53 between the subnetworks. On the other hand, no subnetwork is able to accommodate the data. other networks are then requested to receive the data. As a variant, the subnetwork is not destroyed. However, it may be destroyed on the basis of the subsequent deletion requests.

In an organized base, it is the subnetworks closest to the subnetwork to be destroyed which are requested to receive the data from the subnetwork which is to be destroyed.

Besides permanence, consistency and upgradeability, the partitioned database must allow rapid access to the data. This is because this access needs to be compatible with the response time required by provision of the telecommunication services.

Searching for data in a database requires knowledge of the subnetwork containing the sought information. This search needs to be as fast as possible. The speed of a search is determined by the number of bonds required between the nodes in order to access the sought data. For this, at least one node of each subnetwork knows at least two addresses for nodes which are part of two different subnetworks. By way of example, these subnetworks are called higher subnetwork 41 and lower subnetwork 43 relative to a given subnetwork 42. It is thus possible to track requests just from one subnetwork to another. A one-dimensional grid is therefore created between the subnetworks. In such a structure, the routing performances are in the order of O(n), n being the number of subnetworks. To improve these performances, it is possible to add additional links 53 towards other networks. Thus, by adding in the order of O(log n) connections to each node, it is shown that the routing is performed as O(log n). The nodes, in the other subnetworks, receiving these additional connections are chosen on the basis of a given probabilistic distribution.

The search requests are sent indiscriminately to any of the subnetworks. Indeed, the subnetwork is seen from outside as a segment of the database. The internal structuring of the database is not known and it is therefore not possible to send a request to a level containing the sought data directly.

To improve the routing of the request, the data are organized between the different subnetworks in order to form an organized database. Thus, when a request reaches a subnetwork, the latter is able to reroute this request to the correct subnetwork. By way of example, if a subnetwork responsible for accommodating the data starting with G receives a request for a word starting with the letter M, the redirection will take place in one direction only.

This mode of operation is of benefit to saving passband and the load on the CPUs in the various nodes through which the request passes. Indeed, the number of redirected requests is limited in this way. However, this mode of operation requires that the subnetworks be indexed. By way of example, this index is the first value stored by the nodes of the subnetwork in question.

In an unorganized base, the data are not organized between the subnetworks. In this case, when the request reaches a subnetwork 42 and the information is not found there, this request is disseminated to the higher 41 and lower 43 subnetworks. This bidirectional retransmission is necessary, in this case, because there is no notion of order in the classification of the data. It is therefore important to visit potentially all the data subnetworks. The dissemination of the requests stops naturally when the highest or lowest subnetwork has been reached. Moreover, the dissemination of the requests to the higher or lower subnetworks will allow parallelization of the requests. A plurality of requests, relating to the same information, are therefore simultaneously active across the subnetworks for the data. The probability of finding a subnetwork containing the target data item more quickly is increased. This embodiment avoids the operation of indexing the subnetworks.

It will be noted that when the information is found within the base, the promoter whence the request came is informed of this.

The database organized into subnetworks allows the access times to be limited. This likewise improves the management of critical data and the durability thereof in a dynamic network. These features are compatible with the traditional requirements of performances by the network operators and by the telecommunication service providers. Partitioning the database over a plurality of nodes allows investment in hardware and the associated operating costs to be limited. Indeed, the base is designed to be present on modest terminals. By way of example, these terminals are at the premises of the clients. Moreover, it is not necessary to use centralized servers to manage the database.

What is claimed is:

1. A method for managing a database in a communication network comprising the following steps:
at least some of a segment to be copied from the database is copied to a copied segment;
at least one node which is part of the communication network and intended to receive the copied segment is selected;
wherein the node is selected on the basis of a capacity information item which is characteristic of it.

2. The management method according to claim 1, wherein the copied segment and the segment to be copied are identical.

3. The management method according to claim 1, wherein the node is selected on the basis of a data storage capacity for said node.

4. The management method according to claim 1, wherein the node is selected on the basis of a memory capacity for said node.

5. The management method according to claim 1, wherein the selected node is part of a pair network.

6. The management method according to claim 2, wherein the node is selected on the basis of a data storage capacity for said node.

7. The management method according to claim 2, wherein the node is selected on the basis of a memory capacity for said node.

8. The management method according to claim 3, wherein the node is selected on the basis of a memory capacity for said node.

9. The management method according to claim 2, wherein the selected node is part of a pair network.

10. The management method according to claim 3, wherein the selected node is part of a pair network.

11. The management method according to claim 4, wherein the selected node is part of a pair network.

12. A piece of equipment in a communication network comprising:
means for copying at least some of a segment to be copied from the database to a copied segment; and
means for selecting at least one node which is part of the communication network and intended to receive the copied segment;
wherein in the piece of equipment the selection means are capable of selecting the node on the basis of a capacity information item which is characteristic of it.

13. A communication system including a database which is made up of a plurality of segments stored on a plurality of nodes which are part of a communication network, said nodes comprising pieces of equipment in accordance with claim 12.

14. A communication system according to claim 13, wherein nodes storing identical segments from the database are connected to one another to form subnetworks.

15. A communication system according to claim 13, wherein the connections link the subnetworks to one another.

16. A communication system according to claim 14, wherein the connections link the subnetworks to one another.

17. A computer program comprising portions of code for executing the steps of the method according to claim 1 when a program is executed on said computer.
